(19) United States
(12) Patent Application Publication
(10) Pub. No.: US 2004/0141069 A1
(43) Pub. Date: Jul. 22, 2004

(54) Adjustment for output image of image data

(76) Inventor: Yoshihiro Nakami, Nagano-ken (JP)

Correspondence Address: MARTINE & PENILLA, LLP, 710 LAKEWAY DRIVE, SUITE 170, SUNNYVALE, CA, 94085, US

(21) Appl. No.: 10/634,657

(22) Filed: Aug. 4, 2003

(30) Foreign Application Priority Data
Aug. 7, 2002 (JP) 2002-230161

(51) Int. Cl. H04N 5/225; H04N 5/77; H04N 5/91

(52) U.S. Cl. 348/231.6; 348/207.11; 348/207.2; 348/231.3

(57) ABSTRACT

A CPU 211 determines whether an acquired image file GF is a JPEG data storage file or a TIFF data storage file. In the case of the JPEG data storage file, the CPU 211 subsequently determines coexistence of marker segments APP0 and APP1. In the case of no coexistence of the marker segments APP0 and APP1, the CPU 211 detects a marker segment APP6 and retrieves to obtain GI data GIapp. In the case of no detection of the marker segment APP6, the CPU 211 retrieves to obtain either GI data GItiff or GIexif from a GI tag or an Exif tag of the marker segment APP1. The CPU 211 executes image quality adjustment of JPEG data with the obtained GI data.

### FIELD OF TECHNOLOGY

The present invention relates to an image processing technique that uses shooting information or information on specification of image processing to implement the image processing of image data.

### BACKGROUND OF THE INVENTION

A technique of enhancing the accuracy of image processing of image data generated by any of digital still cameras (DSC), digital video cameras (DVC), scanners, and equivalent devices has practical applications in image processing apparatuses, such as personal computers and printers. One practical technique stores image data generated by the DSC and shooting information (shooting conditions) applied for generation of the image data in an identical file and enables the image processing apparatus to carry out image processing with the shooting information. The image file adopted in this technique is in conformity with the standard of the Exif file format specified by Japan Electronics and Information Technology Industries Association (JEITA).

Another practical technique proposed by the applicant of the invention causes the DSC to output image data related to image processing control information (commands, parameters), which controls image processing executed by the image processing apparatus, thus making the intention of the photographer reflect on the output image.

Out of the information applied for these two techniques, the shooting information is used as reference information of the image processing executed by the image processing apparatus, while the image processing control information is used as the commands (parameters) to direct the image processing executed by the image processing apparatus. The shooting information and the image processing control information are stored at different positions in the image file and may thus be present in an identical file.

In order to give an output image by the techniques discussed above, it is desired to adequately obtain required pieces of information according to the format of the image data (the image file) and execute image processing based on the obtained information.

### SUMMARY OF THE INVENTION

In order to solve the above problems of the prior art technique, the present invention aims to adequately obtain information, which is related to image data and is available for image processing, and to execute image processing according to the obtained information.

A first application of the invention to attain the above object is directed to an image processing method that utilizes either of shooting information representing a shooting condition of image data and image processing control information for specifying an image processing condition of the image data, either of which is related to the image data, and thereby makes the image data subjected to a series of image processing. The image processing method in the first application of the invention acquires the image data; retrieves either of the shooting information and the image processing control information, either of which is related to the acquired image data; and in the case of successful retrieval of the image processing control information, executes the series of image processing of the image data according to the image processing control information.

The image processing method in the first application of the invention retrieves either of the shooting information and the image processing control information, which is related to the acquired image data. In the case of successful retrieval of the image processing control information, the image processing method executes the series of image processing of the image data according to the image processing control information. Namely this procedure obtains the image processing control information for specifying the image processing condition of the image data, as the information that is related to the image data and is available for the image processing, and executes the series of image processing according to the obtained image processing control information.

In one preferable aspect, the image processing method in the first application of the invention does not retrieve the shooting information, in the case of successful retrieval of the image processing information. The image processing control information specifies the image processing condition of the image data and is more adequate for image processing than the shooting information representing the shooting condition.

The first application of the invention is also actualized by an image processing apparatus that utilizes either of shooting information representing a shooting condition of image data and image processing control information for specifying an image processing condition of the image data, either of which is related to the image data, and thereby makes the image data subjected to a series of image processing. The image processing apparatus in the first application of the invention includes: an image data acquisition unit that acquires the image data; an image processing information retrieval unit that retrieves either of the shooting information and the image processing control information, either of which is related to the acquired image data; and an image processing unit that, in the case of successful retrieval of the image processing control information, executes the series of image processing of the image data according to the image processing control information.

The first application of the invention is further actualized by a recording medium in which an image processing program is recorded, where the image processing program causes a computer to utilize either of shooting information representing a shooting condition of image data and image processing control information for specifying an image processing condition of the image data, either of which is related to the image data, and thereby make the image data subjected to a series of image processing. The image processing program in the recording medium in the first application of the invention includes: a program command that acquires the image data; a program command that retrieves either of the shooting information and the image processing control information, either of which is related to the acquired image data; and a program command that, in the case of successful retrieval of the image processing control information, executes the series of image processing of the image data according to the image processing control information.

The image processing apparatus and the recording medium according to the first application of the invention have similar functions and effects to those of the image processing method in the first application of the invention and have various arrangements as discussed above with regard to the image processing method.

A second application of the invention is directed to an image processing method that utilizes either of shooting information representing a shooting condition of image data and image processing control information for specifying an image processing condition of the image data, either of which is related to the image data, and thereby makes the image data subjected to a series of image processing. The image processing method in the second application of the invention acquires the image data; retrieves either of the shooting information and the image processing control information, either of which is related to the acquired image data; and in the case of failed retrieval of the image processing control information but successful retrieval of the shooting information, executes the series of image processing of the image data, based on the shooting information.

The image processing method in the second application of the invention utilizes the shooting information, which is likely to be included in the image file, and even in the case of failed retrieval of the image processing control information, ensures execution of image processing based on at least the shooting condition.

In one preferable aspect, the image processing method in the second application of the invention executes the series of image processing of the image data according to default image processing control information, which is general-purpose image processing information set for preset image data, in the case of failed retrieval of both the image processing control information and the shooting information. This arrangement utilizes neither the image processing control information nor the shooting information, but executes some image quality adjustment based on the default image processing control information.

In the image processing method according to the second application of the invention, it is preferable that the step of executing the image processing converts at least part of the shooting information into image processing control information and executes the series of image processing of the image data according to the converted image processing control information. This procedure converts the shooting information, which is likely to be included in the image file, into the image processing control information and utilizes the converted image processing control information, thus ensuring execution of image processing that is at least closer to the intention of the photographer.

The second application of the invention is also actualized by an image processing apparatus that utilizes either of shooting information representing a shooting condition of image data and image processing control information for specifying an image processing condition of the image data, either of which is related to the image data, and thereby makes the image data subjected to a series of image processing. The image processing apparatus in the second application of the invention includes: an image data acquisition unit that acquires the image data; an image processing information retrieval unit that retrieves either of the shooting information and the image processing control information, either of which is related to the acquired image data; and an image processing unit that, in the case of failed retrieval of the image processing control information but successful retrieval of the shooting information, executes the series of image processing of the image data, based on the shooting information.

The second application of the invention is further actualized by a recording medium in which an image processing program is recorded, where the image processing program causes a computer to utilize either of shooting information representing a shooting condition of image data and image processing control information for specifying an image processing condition of the image data, either of which is related to the image data, and thereby make the image data subjected to a series of image processing. The image processing program in the recording medium in the second application of the invention includes: a computer command that acquires the image data; a computer command that retrieves either of the shooting information and the image processing control information, either of which is related to the acquired image data; and a computer command that, in the case of failed retrieval of the image processing control information but successful retrieval of the shooting information, executes the series of image processing of the image data, based on the shooting information.

The image processing apparatus and the recording medium according to the second application of the invention have similar functions and effects to those of the image processing method in the second application of the invention and have various arrangements as discussed above with regard to the image processing method.

A third application of the invention is directed to an image processing method that utilizes either of shooting information representing a shooting condition of image data and image processing control information for specifying an image processing condition of the image data, either of which is related to the image data, as image processing information and thereby makes the image data subjected to a series of image processing. The image processing method in the third application of the invention acquires the image data; retrieves either of the shooting information and the image processing control information, either of which is related to the acquired image data; and in the case of successful retrieval of the image processing control information, executes the series of image processing of the image data according to the image processing control information, while in the case of failed retrieval of the image processing control information, executing the series of image processing of the image data, based on the shooting information.

The image processing method in the third application of the invention utilizes the image processing control information, which specifies the image processing condition of the image data, in the case of successful retrieval of the image processing control information. In the case of failed retrieval of the image processing control information, on the other hand, the image processing method utilizes the shooting information to execute image processing of the image data. This arrangement ensures execution of image processing based on at least the shooting condition.

In one preferable aspect, the image processing method in the third application of the invention does not execute retrieval of the shooting information, in the case of successful retrieval of the image processing information. The image processing control information specifies the image processing condition of the image data and is more adequate for image processing than the shooting information representing the shooting condition.

In another preferable aspect, the image processing method in the third application of the invention executes the series of image processing of the image data according to default image processing control information, which is general-purpose image processing information set for preset image data, in the case of failed retrieval of both the image processing control information and the shooting information. This arrangement utilizes neither the image processing control information nor the shooting information, but executes some image quality adjustment based on the default image processing control information.

In the image processing method according to the third application of the invention, it is preferable that the executing the image processing to the image data is carried out by converting at least part of the shooting information into image processing control information and executing the series of image processing of the image data according to the converted image processing control information. This procedure converts the shooting information, which is likely to be included in the image file, into the image processing control information and utilizes the converted image processing control information, thus ensuring execution of image processing that is at least closer to the intention of the photographer.

The third application of the invention is also actualized by an image processing apparatus that utilizes either of shooting information representing a shooting condition of image data and image processing control information for specifying an image processing condition of the image data, either of which is related to the image data, as image processing information and thereby makes the image data subjected to a series of image processing. The image processing apparatus in the third application of the invention includes: an image data acquisition unit that acquires the image data; an image processing information retrieval unit that retrieves either of the shooting information and the image processing control information, either of which is related to the acquired image data; and an image processing unit that, in the case of successful retrieval of the image processing control information, executes the series of image processing of the image data according to the image processing control information, while in the case of failed retrieval of the image processing control information, executing the series of image processing of the image data, based on the shooting information.

The third application of the invention is further actualized by a recording medium in which an image processing program is recorded, where the image processing program causes a computer to utilize either of shooting information representing a shooting condition of image data and image processing control information for specifying an image processing condition of the image data, either of which is related to the image data, as image processing information and thereby make the image data subjected to a series of image processing. The image processing program in the recording medium in the third application of the invention includes: a program command that acquires the image data; a program command that retrieves either of the shooting information and the image processing control information, either of which is related to the acquired image data; and a program command that, in the case of successful retrieval of the image processing control information, executes the series of image processing of the image data according to the image processing control information, while in the case of failed retrieval of the image processing control information, executing the series of image processing of the image data, based on the shooting information.

The image processing apparatus and the recording medium according to the third application of the invention have similar functions and effects to those of the image processing method in the third application of the invention and have various arrangements as discussed above with regard to the image processing method.

A fourth application of the invention is directed to an image processing method that carries out a series of image processing with an image file that stores image data and at least either of shooting condition, which represents a condition of generating the image data, and image processing control information, which specifies an image processing condition applied for processing of the image data and has a preset storage position according to a record format. The image processing method in the fourth application of the invention acquires the image file; specifies the record format included in the acquired image file; retrieves the image processing control information at the preset storage position according to the specified record format; and in the case of successful retrieval of the image processing control information, executes the series of image processing of the image data according to the retrieved image processing control information.

The image processing method in the fourth application of the invention retrieves the image processing control information at the preset storage position according to the record format of the image file. This procedure ensures adequate acquisition of the image processing control information according to the image file and execution of image processing based on the acquired image processing control information.

The image processing method in the fourth application of the invention may retrieve the shooting information, in the case of failed retrieval of the image processing control information at the preset storage position. In the case of successful retrieval of the shooting information, the image processing method converts at least part of the retrieved shooting information into image processing control information, and executes the series of image processing of the image data according to the converted image processing control information. This procedure converts the shooting information, which is likely to be included in the image file, into the image processing control information and utilizes the converted image processing control information, thus ensuring execution of image processing that is at least closer to the intention of the photographer.

In one preferable aspect of the image processing method according to the fourth application of the invention, the image file is a JPEG data storage file having at least either of a first application marker segment, which is capable of storing the image processing control information, and a second application marker segment, which is capable of storing at least either of the image processing control information and the shooting information on an identical hierarchy. The retrieving the image processing control information is sequentially carried out firstly at the preset storage position in the first application marker segment, and then at the preset storage position in the second application marker segment. This arrangement ensures adequate retrieval of the image processing control information according to the file format of the JPEG data storage file.

In another preferable aspect of the image processing method according to the fourth application of the invention, the image file is a JPEG data storage file having at least either of a first application marker segment, which is capable of storing the image processing control information, and a second application marker segment, which is capable of storing at least either of the image processing control information and the shooting information on an identical hierarchy. The retrieving the image processing control information is sequentially carried out firstly at the preset storage position in the first application marker segment, and then at the preset storage position in the second application marker segment. This arrangement ensures adequate retrieval of the image processing control information according to the file format of the JPEG data storage file.

It is preferable that the image processing method in the fourth application of the invention further retrieves the shooting information in the second application marker segment, wherein the second application marker segment is capable of storing the image processing control information on a lower hierarchy than the shooting information. In the case of failed retrieval of the image processing control information at the preset storage positions in the first application marker segment and in the second application marker segment and successful retrieval of the shooting information by the shooting information retrieval means, the image processing method carries out retrieval of the image processing control information on the lower hierarchy than the shooting information in the second application marker segment. This arrangement ensures adequate retrieval of the image processing control information according to the file format of the JPEG data storage file.

In the image processing method of this embodiment according to the fourth application of the invention, in the case of failed retrieval of the image processing control information on the lower hierarchy than the shooting information in the second application marker segment, one preferable procedure converts at least part of the shooting information into image processing control information and executes the series of image processing of the image data according to the converted image processing control information. This procedure converts the shooting information, which is likely to be included in the image file, into the image processing control information and utilizes the converted image processing control information, thus ensuring execution of image processing that is at least closer to the intention of the photographer.

In still another preferable aspect of the image processing method according to the fourth application of the invention, the image file is a TIFF file having at least either of a first image file directory, which is capable of storing the image processing control information, and a second image file directory, which is capable of storing the shooting information. The retrieving the image processing control information is sequentially carried out firstly in the first image file directory, and then in the second image file directory. This arrangement ensures adequate retrieval of the image processing control information according to the file structure of the TIFF file.

It is preferable that the image processing method in the fourth application of the invention further retrieves the shooting information in the second image file directory, wherein the second image file directory is capable of storing the image processing control information on a lower hierarchy than the shooting information. In the case of failed retrieval of the image processing control information in the first image file directory and successful retrieval of the shooting information by the shooting information retrieval means, the image processing method retrieves the image processing control information on the lower hierarchy than the shooting information in the second image file directory. This arrangement ensures adequate retrieval of the image processing control information according to the file structure of the TIFF file.

In the image processing method of this embodiment according to the fourth application of the invention, in the case of failed retrieval of the image processing control information on the lower hierarchy than the shooting information in the second image file directory, one preferable procedure converts at least part of the shooting information into image processing control information and executes the series of image processing of the image data according to the converted image processing control information. This procedure converts the shooting information, which is likely to be included in the image file, into the image processing control information and utilizes the converted image processing control information, thus ensuring execution of image processing that is at least closer to the intention of the photographer.

The fourth application of the invention is also actualized by an image processing apparatus that carries out a series of image processing with an image file that stores image data and at least either of shooting condition, which represents a condition of generating the image data, and image processing control information, which specifies an image processing condition applied for processing of the image data and has a preset storage position according to a record format. The image processing apparatus in the fourth application of the invention includes: an image file acquisition unit that acquires the image file; a format specification unit that specifies the record format included in the acquired image file; an image processing control information retrieval unit that retrieves the image processing control information at the preset storage position according to the specified record format; and an image processing unit that, in the case of successful retrieval of the image processing control information, executes the series of image processing of the image data according to the retrieved image processing control information.

The fourth application of the invention is further actualized by a recording medium in which an image processing program is stored, where the image processing program causes a computer to carry out a series of image processing with an image file that stores image data and at least either of shooting condition, which represents a condition of generating the image data, and image processing control information, which specifies an image processing condition applied for processing of the image data and has a preset storage position according to a record format. The image processing program in the recording medium in the fourth application of the invention includes: a program command that acquires the image file; a program command that specifies the record format included in the acquired image file; a program command that retrieves the image processing control information at the preset storage position according to the specified record format; and a program command that, in the case of successful retrieval of the image processing control information, executes the series of image processing of the image data according to the retrieved image processing control information.

The image processing apparatus and the recording medium according to the fourth application of the invention have similar functions and effects to those of the image processing method in the fourth application of the invention and have various arrangements as discussed above with regard to the image processing method.

A fifth application of the invention is directed to an image processing method that carries out a series of image processing with an image file that stores JPEG data and at least one of an application marker segment APP0, which represents a JFIF file, an application marker segment APP1, which is capable of storing shooting information representing a condition of generating image data, as well as image processing control information for specifying an image processing condition applied for the processing of the image data on an identical hierarchy and represents an Exif file, and an application marker segment APP6, which is capable of storing the image processing control information. The image processing method in the fifth application of the invention acquires the image file; detects one or multiple application marker segments; and in the case of simultaneous detection of the application marker segment APP0 and the application marker segment APP1 by the detection means, does not execute the series of image processing of the image data according to the image processing control information.

The image processing method in the fifth application of the invention does not execute the image processing according to the image processing control information, in the case of failed specification of the image file as an image file in conformity with the JFIF file format or as an image file in conformity with the Exif file format. The failed specification results in mistakenly retrieving and obtaining the image processing control information and leads to inadequate image quality adjustment with the wrong pieces of information. This arrangement effectively prevents inadequate image processing with wrong pieces of information.

In one preferable aspect, the image processing method in the fifth application of the invention executes the series of image processing of the image data according to the image processing control information, in the case of detection of any of the application marker segment APP1, a combination of the application marker segment APP1 and the application marker segment APP6, and a combination of the application marker segment APP0 and the application marker segment APP6, executing. In such cases, the procedure adequately retrieves and acquires the image processing control information from either of an image file in conformity with the Exif file format or an image file in conformity with the JFIF file format, and executes appropriate image quality adjustment according to the acquired image processing control information.

The fifth application of the invention is also actualized by an image processing apparatus that carries out a series of image processing with an image file that stores JPEG data and at least one of an application marker segment APP0, which represents a JFIF file, an application marker segment APP1, which is capable of storing shooting information representing a condition of generating image data, as well as image processing control information for specifying an image processing condition applied for the processing of the image data on an identical hierarchy and represents an Exif file, and an application marker segment APP6, which is capable of storing the image processing control information. The image processing apparatus in the fifth application of the invention includes: an image file acquisition unit that acquires the image file; a detection unit that detects one or multiple application marker segments; and an image processing unit that, in the case of simultaneous detection of the application marker segment APP0 and the application marker segment APP1 by the detection means, does not execute the series of image processing of the image data according to the image processing control information.

The fifth application of the invention is further actualized by a recording medium in which an image processing program is stored, where the image processing program causes a computer to carry out a series of image processing with an image file that stores JPEG data and at least one of an application marker segment APP0, which represents a JFIF file, an application marker segment APP1, which is capable of storing shooting information representing a condition of generating image data, as well as image processing control information for specifying an image processing condition applied for the processing of the image data on an identical hierarchy and represents an Exif file, and an application marker segment APP6, which is capable of storing the image processing control information. The image processing program in the recording medium in the fifth application of the invention includes: a program command that acquires the image file; a program command that detects one or multiple application marker segments; and a program command that, in the case of simultaneous detection of the application marker segment APP0 and the application marker segment APP1 by the detection means, does not execute the series of image processing of the image data according to the image processing control information.

The image processing apparatus and the recording medium according to the fifth application of the invention have similar functions and effects to those of the image processing method in the fifth application of the invention and have various arrangements as discussed above with regard to the image processing method.

### BRIEF DESCRIPTION OF THE DRAWINGS

FIG. 1 shows an image processing system, to which an image processing apparatus of one embodiment is applicable;

FIG. 2 is a block diagram schematically showing the structure of a color printer functioning as the image processing apparatus of the embodiment;

FIG. 3 shows the internal structure of a JPEG data storage file on the level of application marker segments (APP) to explain the file format of the JPEG data storage file that stores JPEG data;

FIG. 4 shows the general file structure of the JPEG data storage file that stores JPEG data;

FIG. 5 shows the detailed internal structure of APP6 used in the embodiment;

FIG. 6 shows the data structure of GI data that stores image processing control information GI used in this embodiment;

FIG. 7 shows the detailed internal structure of APP1 used in the embodiment;

FIG. 8 is a block diagram showing the detailed internal structure of Exif IFD in the Exif file format used in the embodiment;

FIG. 9 shows the internal structure of a TIFF file on the level of IFD to explain the TIFF file format;

FIG. 10 shows the general file structure of the TIFF file;

FIG. 11 is a flowchart showing an image processing routine executed by the image processing apparatus of the embodiment (the color printer 20);

FIG. 12 is a flowchart showing an image quality adjustment routine with GIapp data executed by the image processing apparatus of the embodiment (the color printer 20);

FIG. 13 is a flowchart showing an image quality adjustment routine with GItiff data or GIexif data executed by the image processing apparatus of the embodiment (the color printer 20);

FIG. 14 is a flowchart showing an image quality adjustment routine with Exif data converted into GI-equivalent data executed by the image processing apparatus of the embodiment (the color printer 20); and

FIG. 15 shows one exemplified mapping of shooting information PI to GI-equivalent data GI′.

### DETAILED DESCRIPTION OF THE PREFERRED EMBODIMENTS

The image processing apparatus of the invention is discussed below as a preferred embodiment with reference to the accompanied drawings.

A. Construction of Image Processing System

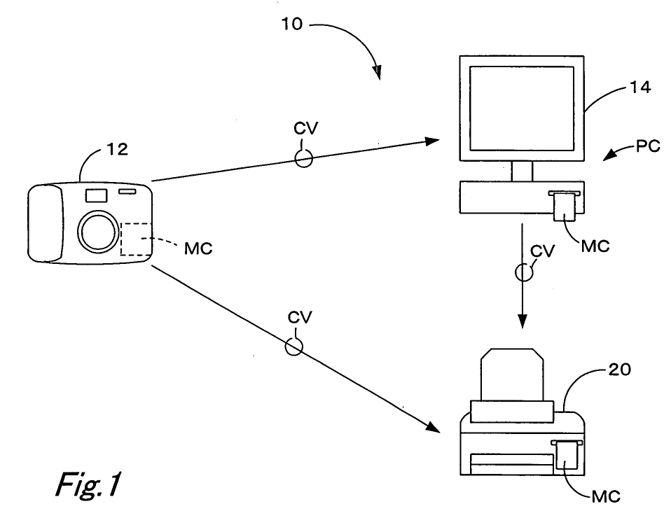

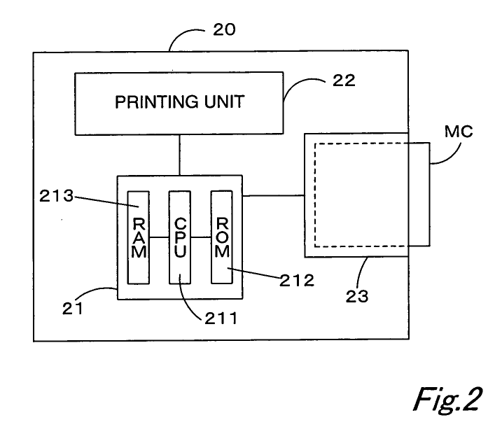

The construction of an image processing system including an image processing apparatus in one embodiment is discussed below with reference to FIGS. 1 and 2. FIG. 1 shows an image processing system, to which an image processing apparatus of one embodiment is applicable. FIG. 2 is a block diagram schematically showing the structure of a color printer functioning as the image processing apparatus of the embodiment.

An image processing system 10 includes a digital still camera 12 functioning as an input device to generate image data, a personal computer PC functioning as an image processing apparatus that executes image processing of the image data generated by the digital still camera 12, and a color printer 20 functioning as an output device to output images. The output device is not restricted to the printer 20 but may be, for example, a monitor 14 such as a CRT display, an LCD display and a projector. In the description below, the color printer 20 is used as the output device.

The digital still camera 12 focuses light information on a digital device (for example, a CCD or an electron multiplier tube) to electrically acquire an image, and has an optical circuit including the CCD or the like to collect the light information, an image acquisition circuit that controls the optical circuit to acquire a digital image, an image processing circuit that processes the acquired digital image, and a control circuit that has a memory for temporarily storing various data and controls the respective circuits. The digital still camera 12 stores the acquired images as digital data into a memory device, such as a memory card MC. The JPEG data format as an irreversible compression system and the TIFF data format as a reversible compression system are typically applied for storage of image data in the digital still camera 12. Other storage formats like the RAW data format, the GIF data format, and the BMP data format are also applicable for storage of image data.

The digital still camera 12 used for the image data output system 10 relates at least either of image processing control information GI, which controls image processing of image data GD executed by the image processing apparatus (the color printer 20 and the personal computer PC), and image data shooting information PI to the image data GD and stores the related image data GD in the form of an image file GF into the memory card MC. The image processing control information GI includes parameters for specifying image processing conditions to attain optimum image output results by taking into account the color reproduction characteristics and the image output characteristics of the output device like the color printer 20. The shooting information PI represents shooting conditions including the shutter speed, the aperture, and the ISO speed at the time of photographing.

The image file GF generated by the digital still camera 12 is transmitted to the color printer 20 via the cable CV and the computer PC or directly via the cable CV. The image file GF is otherwise transmitted to the color printer 20 by inserting the memory card MC, in which the image file GF has been stored by the digital still camera 12, into a memory card slot of the computer PC or by directly connecting the memory card MC with the printer 20. In the structure of the embodiment the color printer 20 is stand-alone to execute the image processing and output (printing) process.

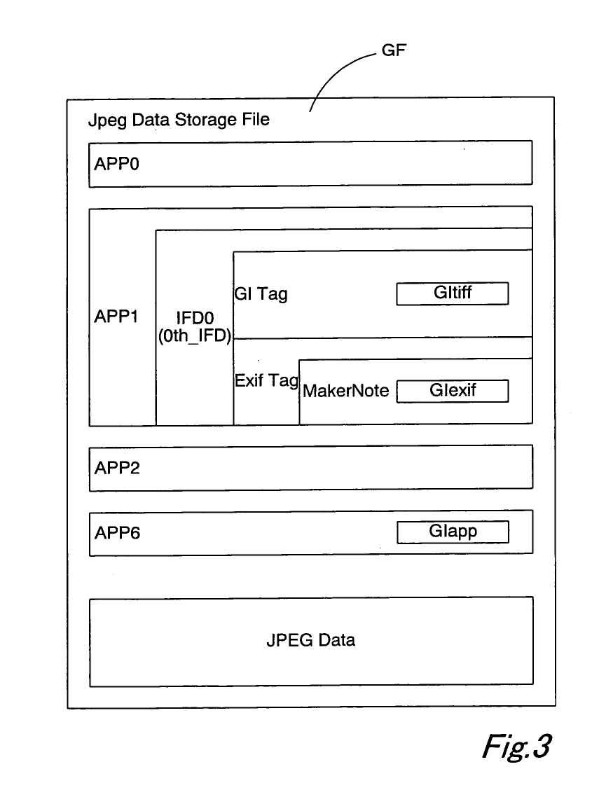

The color printer 20 shown in FIG. 3 is capable of outputting color images and is, for example, an ink jet printer that ejects four color inks, cyan (C), magenta (M), yellow (Y), and black (K), on a printing medium to create a dot pattern and thereby form an image. Another example of the color printer 20 is an electrophotographic printer that transfers and fixes color toners on a printing medium to form an image. Other color inks, light cyan (LC), light magenta (LM), and dark yellow (DY) may also be used, in addition to the above four color inks.

The color printer 20 has a control circuit 21 that executes image processing of the image data GD and control of the respective constituents of the color printer 20, a printing unit 22 that includes a print head or a tumbling barrel and functions to print image-processed image data on a printing medium, and a slot 23 that receives the memory card MC therein. The control circuit 21 includes a central processing unit (CPU) 211 that executes various operations including image processing, a read only memory (ROM) 212 that stores programs executed by the CPU 211 in an involatile manner, and a random access memory (RAM) 213 that temporarily stores the results of the operations by the CPU 211 and data obtained. The control circuit 21 retrieves the image processing control information GI in the image file read from the memory card MC and executes image processing (image quality adjustment) of the image data GD based on the retrieved image processing control information GI. The control circuit 21 also controls the movements of a sheet feed motor, a carried motor, a print head, and other relevant elements (not shown).

B. Structure of Image File

The image file GF of this embodiment may have, for example, a file structure in conformity with the Exif format (Exif file) that was specified as a standard of the image file format for digital still cameras by Japan Electronics and Information Technology Industries Association (JEITA), a file structure in conformity with the JFIF format (JFIF file) that was specified as a standard for making JPEG data files compatible by three corporations, C-Cube Microsystems, Xing Technology, and Digital Origin (Radius), or a file structure in conformity with the TIFF format (TIFF file) that specifies parameters relating to image data in the form of tags. The Exif files are classified by the type of image data stored therein into JPEG-Exif files that store JPEG image data in a compressed form and TIFF-Exif files that store TIFF image data in a non-compressed form.

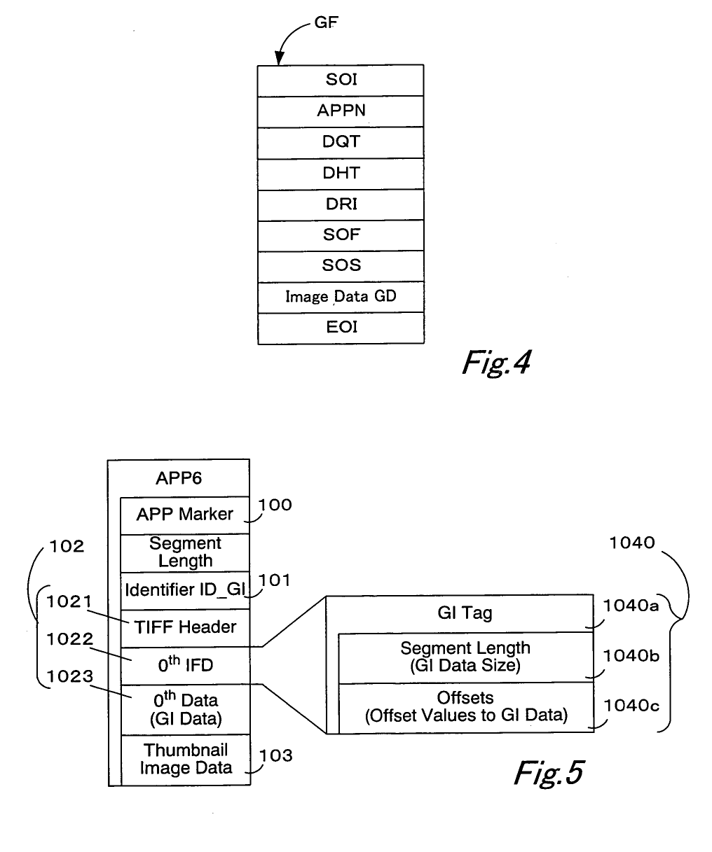

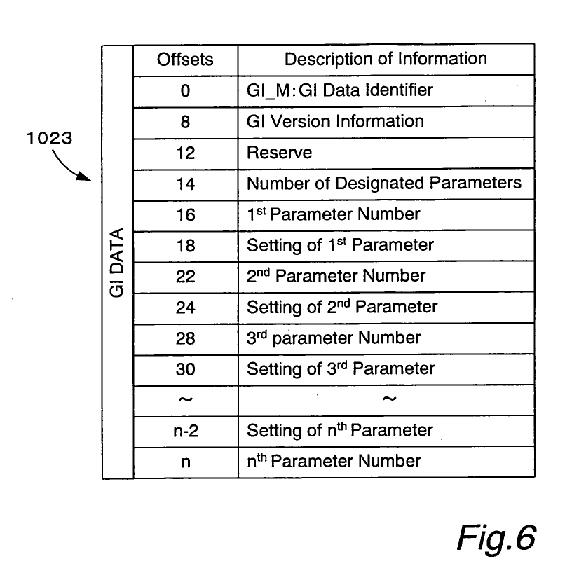

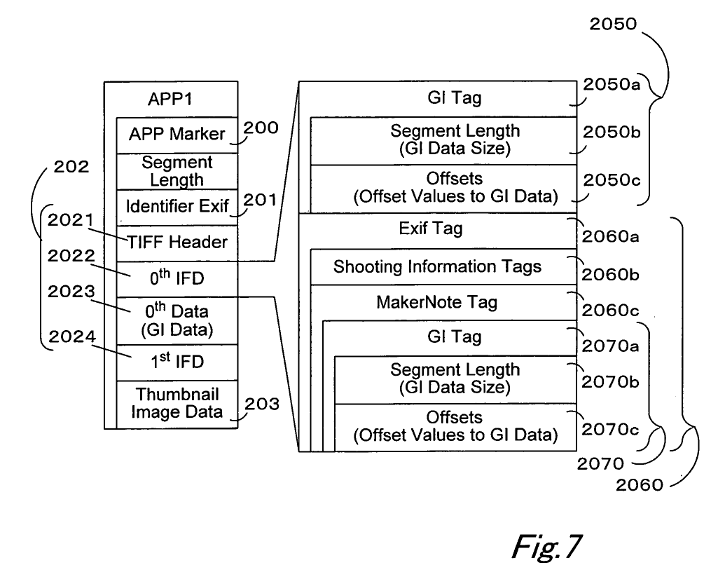

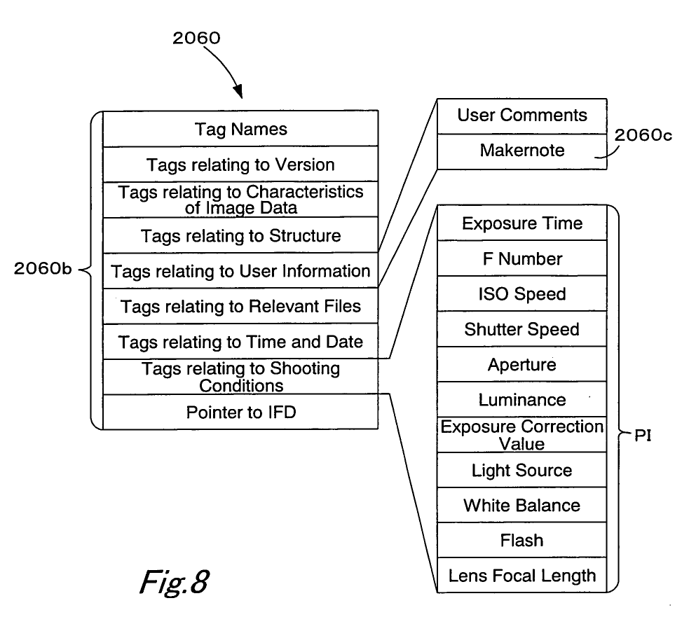

The general structure of the image file in conformity with the JPEG data storage file format used in this embodiment is discussed below with reference to FIGS. 3 through 9. FIG. 3 shows the internal structure of a JPEG data storage file on the level of application marker segments (APP) to explain the file format of the JPEG data storage file that stores JPEG data. FIG. 4 shows the general file structure of the JPEG data storage file that stores JPEG data. FIG. 5 shows the detailed internal structure of APP6 used in the embodiment. FIG. 6 shows the data structure of GI data that stores image processing control information GI used in this embodiment. FIG. 7 shows the detailed internal structure of APP1 used in the embodiment. FIG. 8 is a block diagram showing the detailed internal structure of Exif IFD in the Exif file format used in the embodiment. The terminology ‘file structure’, ‘data structure’, and ‘storage area’ used in this embodiment represents the image of a file or data in the storage state in a storage device.

The description first regards the basic file format of the JPEG data storage file with reference to FIG. 3. As mentioned previously, the JFIF file and Exif file are generally applied for the JPEG data storage file. The JPEG data storage file has application marker segments and JPEG data in the file format. The JPEG data storage file including a 0^{th} application marker segment APP0 complies with the JFIF format. The JPEG data storage file including only a 1^{st} application marker segment APP1 or a combination of 1^{st} and 2^{nd} application marker segments APP and APP2 complies with the Exif format. The application marker segment APP2 is also usable to store an ICC profile.

A 6^{th} application marker segment APP6 is used to store the image processing control information GI as GIapp data. The image processing control information GI is also storable in a GI tag included in the marker segment APP1 as GItiff data and in an Exif tag as GIexif data. As a matter of convenience, the subscripts ‘app’, ‘tiff’, and ‘exif’ are attached to the GI data to show the different storage positions, although the contents of the data are identical. The detailed file structure in each file format will be discussed later.

The general internal structure of the JPEG data storage file is described with reference to FIG. 4. The JPEG data storage file (image file GF) has multiple marker segments and JPEG image data GD. The multiple marker segments include a marker segment SOI that represents the start of segment compressed data, application marker segments APPn (n represents numerals) that store information (data) specified in the respective file formats, a marker segment DQT that defines a quantization table, a marker segment DHT that defines a Huffman table, a marker segment DRI that defines an insertion interval of a restart marker, a marker segment SOF that represents various parameters relating to frames, a marker segment SOS that represents various parameters relating to scan, and a marker segment EOI that represents the end of the compressed data. The compressed image data GD is stored between the marker segment SOS and the marker segment EOI. The recording sequence of the respective marker segments is set arbitrarily, except that the marker segments APPn are to be recorded immediately after the SOI marker segment and that the marker segment SOS is to be recorded immediately before the marker segment EIO across the image data GD.

The detailed structure of the marker segment APP6 is described with reference to FIG. 5. The marker segment APP6 includes an APP marker 100 that identifies the marker segment as APP6, an identifier ID_GI 101 that identifies the marker segment to store the image processing identification information GI therein, attribute information 102, and a thumbnail image 103. The attribute information 102 has a file structure in conformity with the TIFF file format, and includes a TIFF header 1021, 0^{th}_IFD 1022 that describes attribute information relating to GI data, which represents data values of the image processing control information GI, and 0^{th} data 1023 that describes the GI data.

A byte order corresponding to the CPU, version information of TIFF, and information relating to offsets to a first IFD are described in the TIFF header 1021. In the marker segment APP6, the first IFD is 0^{th}_IFD, so that offset values to the 0^{th}_IFD 1022 are written in the TIFF header. The IFD uses tags to identify respective pieces of information. The respective pieces of information may thus be expressed by the tag names.

A GI tag number 1022a that identifies a tag relating to the image processing control information GI and is used to retrieve a GI tag, a segment length 1022b that represents a GI data size, and offset values 1022c from the TIFF header 1021 to the GI data (0^{th} data 1023) are described in the 0^{th}_IFD 1022.

As shown in FIG. 6, the GI data representing the data values of the image processing control information GI include various pieces of information, for example, identifier information that identifies the GI data, version information of the GI data, and values of various parameters relating to image quality adjustment of the image data. The various parameters relating to the image quality adjustment in the GI data include color space matrix elements that specify a color space used for image processing executed by the color printer 20 and the personal computer PC, correction values for the specified color space, and parameters relating to the image quality, such as contrast, color balance adjustment, sharpness, and color correction.

The detailed structure of the marker segment APP1 is described with reference to FIG. 7. All the application marker segments APPn have an identical basic data structure after the TIFF header. The pieces of information described previously with regard to the marker segment APP6 are thus omitted from the explanation here.

The marker segment APP1 includes an APP marker 200 that identifies the marker segment as APP1, an identifier Exif 201 that identifies the marker segment to store Exif information therein, attribute information 202, and a thumbnail image 203. The attribute information 202 includes a TIFF header 2021, 0^{th}_IFD 2022 that describes various pieces of information relating to a main image and including the Exif information and the image processing control information GI, 0^{th} data 2023 that describes Exif data and GI data, and 1^{st}_IFD 2024 that describes various pieces of information relating to thumbnail image data.

The 0^{th}_IFD 2022 includes at least either of a GI tag 2050 that stores information relating to the image processing control information GI and an Exif tag 2060 that stores information relating to the Exif information as data on an identical hierarchy. A GI tag number 2050a that identifies a GI tag and is used to retrieve the GI tag, a segment length 2050b that represents a GI data size, and offset values 2050c from the TIFF header 2021 to the GI data (0^{th} data 2023) are described in the GI tag 2050. As shown in FIG. 8, the Exif tag 2060 is a set of multiple tags representing version information of Exif, color space information, date and time when image data was generated, and shooting conditions. The Exif tag 2060 includes an Exif tag number 2060a that identifies an Exif tag and is used to retrieve the Exif tag and various shooting information tags 2060b. Tag numbers have been allocated in advance to the respective shooting information tags 2060b. A reader for reading out the Exif tag uses a tag number allocated in advance to retrieve each required shooting information tag 2060b.

As shown in FIGS. 7 and 8, the shooting information tags 2060b include a Makernote tag 2060c that is open to a user (manufacturer) as a tag relating to user information. The Makernote tag 2060c further includes a GI tag 2070 that describes the image processing control information GI. A GI tag number 2070a that identifies a GI tag and is used to retrieve the GI tag, a segment length 2070b that represents a GI data size, and offset values 2070c from the TIFF header 2021 to the GI data (0^{th} data 2023) are described in the GI tag 2070.

The shooting information tags 2060b in the Exif tag 2060 include tags relating to the shooting conditions, as shown in FIG. 8. The tags relating to the shooting conditions (shooting information PI) store values of respective parameters, exposure time, lens F number, exposure control mode, ISO sensitivity, exposure correction value, light source, white balance, flash, and focal length, according to preset offsets. The shooting information PI represents information relating to the image quality (image quality generation information) when image data is generated (when an image is taken) by an image data generation device, such as the digital still camera 12. Some of the parameters including the exposure time and the ISO sensitivity are automatically recorded in the shooting process, while the other parameters including the exposure correction value and the light source are set arbitrarily by the user.

The actual image file GF may have an arbitrary combination of the marker segments APP0, APP1, APP2, and APP6. For treatment as a file in conformity with the Exif file format, the image file GF is required to have the marker segments APP1 and APP2 and the Exif identifier. When the image file GF complies with the Exif file format, the Exif tag may be referred to as Exif_IFD, which is specified as offsets from the TIFF header stored in the 0^{th}_IFD. For treatment as a file in conformity with the JFIF file format, the image file GF is required to have the marker segment APP0. The image processing control information GI may be described in the marker segments APP in these various forms. The image processing control information GI is thus adequately storable according to the required file structure without changing the file format, which the image file GF complies with.

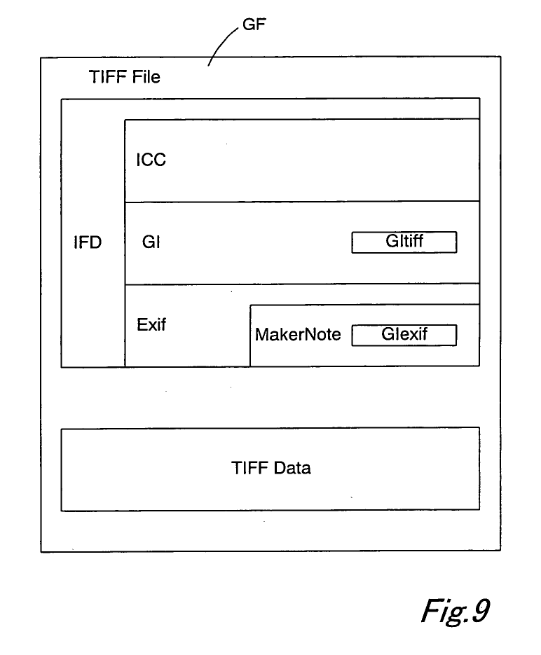

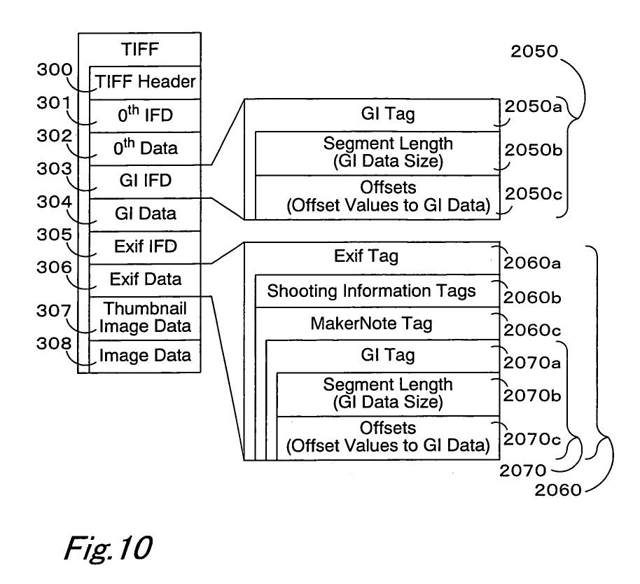

The general structure of the image file in conformity with the TIFF file format used in this embodiment is discussed below with reference to FIGS. 9 and 10. FIG. 9 shows the internal structure of a TIFF file on the level of IFD to explain the TIFF file format. FIG. 10 shows the general file structure of the TIFF file. The terminology ‘file structure’, ‘data structure’, and ‘storage area’ used in this embodiment represents the image of a file or data in the storage state in a storage device.

The description first regards the TIFF file format with reference to FIG. 9. Information regarding the image data GD is described as tag information in the TIFF file. TIFF data in the non-compressed form are generally stored in the TIFF file, although JPEG data in the compressed form are also storable in the TIFF file. Various pieces of information relating to the image data are stored in units of IFD (image file directory) in the TIFF file. In the illustrated example of FIG. 9, the TIFF file includes ICC_IFD that describes an ICC profile, Exif_IFD that describes the Exif information, and GI_IFD that describes the image processing control information GI. The image processing control information GI may be described as GItiff data in the GI_IFD and described as GIexif data in Makernote of the Exif_IFD.

The TIFF file format is discussed in further detail with reference to FIG. 10. The TIFF file includes a TIFF header 300, 0^{th}_IFD 301, 0^{th} data 302, GI_IFD 303, GI data 304, Exif_IFD 305, Exif data 306, thumbnail image data 307, and main image data 308. The JPEG data storage file described above with reference to FIGS. 3 through 8 utilizes the tag structure in the TIFF file to describe the various pieces of information relating to the JPEG data. The structure after the TIFF header in the TIFF file has thus already been explained and is not specifically described here. The lower hierarchical structure of the GI_IFD 303 and the Exif_IFD 305 is equivalent to the structure of the GI tag 2050 and the Exif tag 2060 included in the marker segment APP1 as shown in FIG. 7 and described above. These elements are expressed by the same numerals and are not specifically described here.

C. Image Processing Executed by Color Printer 20

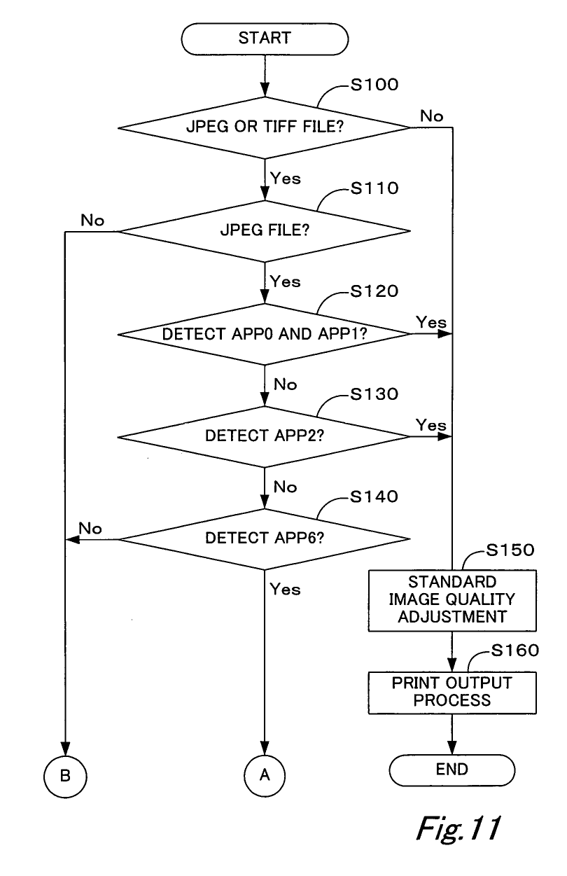

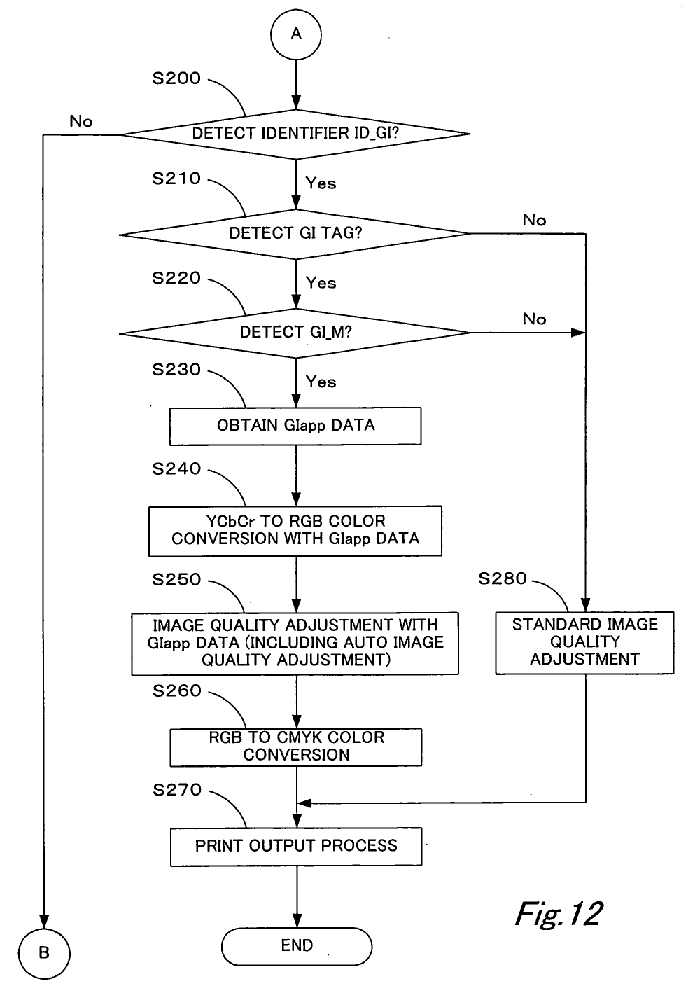

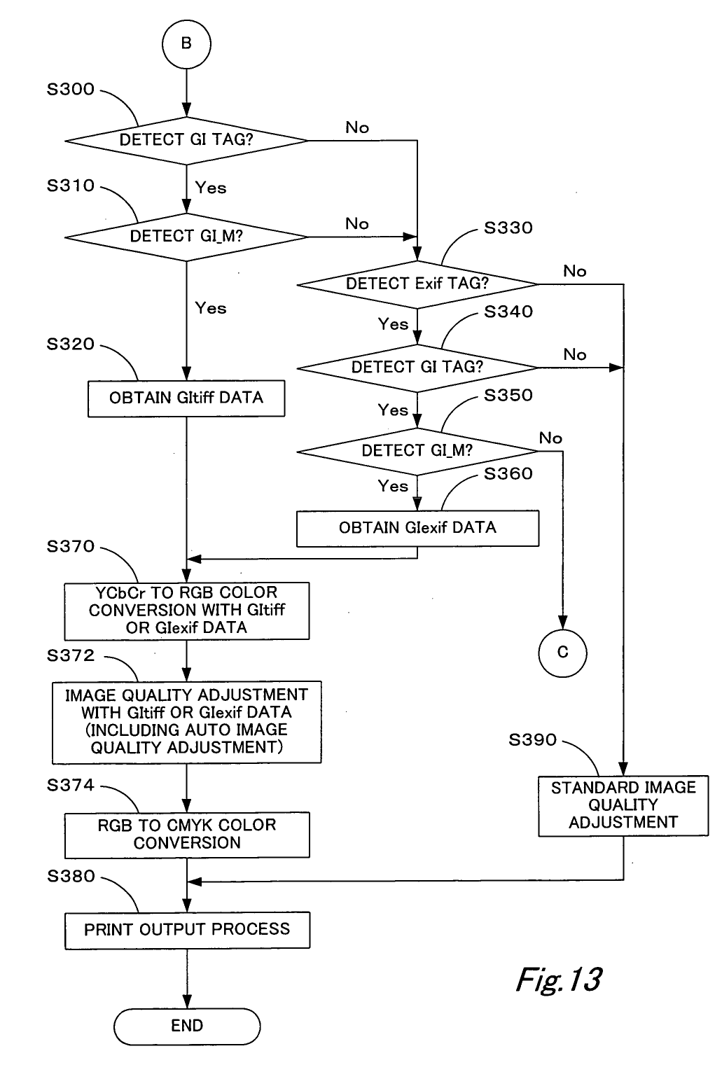

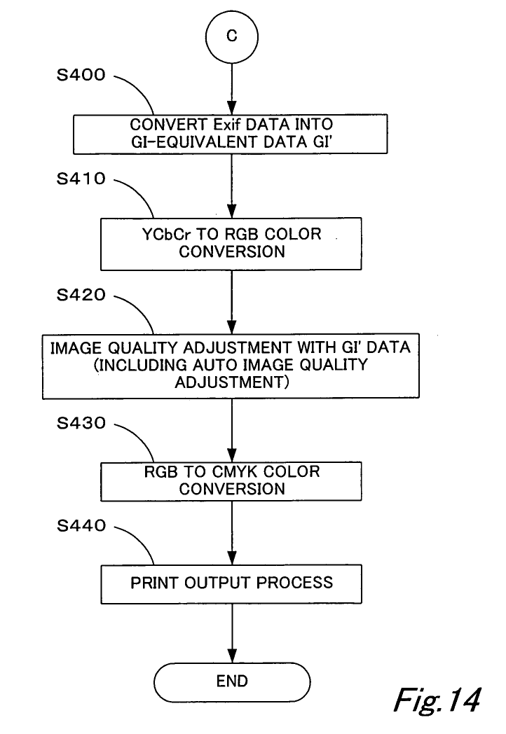

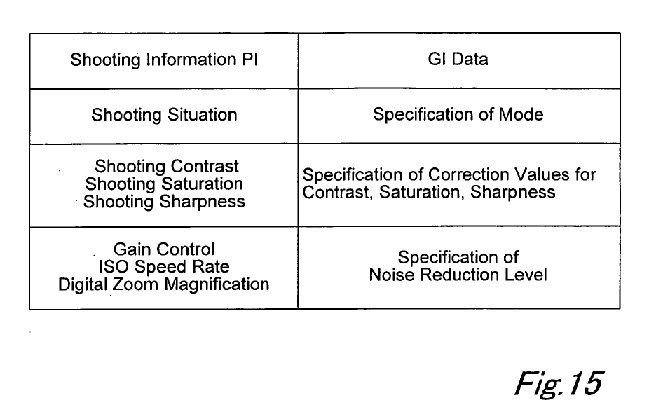

A series of image processing executed by the color printer 20 is discussed below with reference to FIGS. 11 through 15. FIG. 11 is a flowchart showing an image processing routine executed by the image processing apparatus of the embodiment (the color printer 20). FIG. 12 is a flowchart showing an image quality adjustment routine with GIapp data executed by the image processing apparatus of the embodiment (the color printer 20). FIG. 13 is a flowchart showing an image quality adjustment routine with GItiff data or GIexif data executed by the image processing apparatus of the embodiment (the color printer 20). FIG. 14 is a flowchart showing an image quality adjustment routine with Exif data converted into GI-equivalent data executed by the image processing apparatus of the embodiment (the color printer 20). FIG. 15 shows one exemplified mapping of shooting information PI to GI-equivalent data GI′.

When the memory card MC is inserted into the slot 23, the control circuit 21 (CPU 211) of the color printer 20 reads the image file GF from the memory card MC and temporarily stores the read-out image file GF in the RAM 213. The CPU 211 determines whether the image file GF is either a JPEG file storing JPEG data or a TIFF file or data, based on an extension of the image file GF (step S100). When it is determined that the image file GF is either a JPEG file or a TIFF file, that is, when the extension is either ‘jpg’ or ‘tif’ (step S100: Yes), the CPU 211 subsequently determines whether the image file GF is a JPEG file (step S110).

When it is determined that the image file GF is neither a JPEG file nor a TIFF file (step S100: No), on the other hand, the CPU 211 carries out standard image quality adjustment without the image processing control information GI (GI data) (step S150) and then a print output process (step S160), before exiting from this processing routine. In the print output process, the CPU 211 successively executes a halftoning process and a resolution conversion process and transmits the processed data as raster data to the printing unit 21. The program then terminates the processing routine.

When it is determined that the image file GF is a JPEG file (step S10: Yes), the CPU 211 determines whether both APP markers representing the marker segments APP0 and APP1 are detected in the image file GF (step S120). When both of the marker segments APP0 and APP1 are detected in the image file GF (step S120: Yes), the CPU 211 goes to step S160. In the case of detection of both the marker segments APP0 and APP1, it is impossible to determine whether the image file GF complies with the JFIF file format or the Exif file format. In this case, the CPU 211 fails to adequately specify (detect) the location of the GI data and thereby skips the image quality adjustment with the image processing control information GI.

When both of the marker segments APP0 and APP1 are not detected in the image file GF (step S120: No), the CPU 211 subsequently determines whether an APP marker representing the marker segment APP2 is detected in the image file GF (step S130). In the case of detection of the marker segment APP2 in the image file GF (step S130: Yes), the CPU 211 goes to step S160. The image file having the marker segment APP2 is virtually defined as an image file having an ICC profile, so that the CPU 211 skips the image quality adjustment with the image processing control information GI.

The decisions at steps S120 and S130 are executed to enhance the detection accuracy of the image processing control information GI and give priority to the current defect standards and are not essential for this processing routine (namely they may be omitted from this processing routine).

In the case of no detection of the marker segment APP2 in the image file GF (step S130: No), the CPU 211 subsequently determines whether an APP marker representing the marker segment APP6 is detected in the image file GF (step S140). In the case of detection of the marker segment APP6 in the image file GF (step S140: Yes), the CPU 211 goes to A in FIG. 12. In the case of no detection of the marker segment APP5 in the image file GF (step S140: No), on the other hand, the CPU 211 goes to B in FIG. 13.

A subsequent flow of the processing (after A) in the case of detection of the marker segment APP6 in the image file GF is discussed below by referring to FIG. 12. The subsequent flow of the processing executes image quality adjustment with the image processing control information GI (GI data) described in the marker segment APP6, in response to detection of the marker segment APP6.

The CPU 211 determines whether the identifier ID_GI representing inclusion of the image processing control information GI is detected in the marker segment APP6 (step S200). In the case of failed detection of the identifier ID_GI (step S200: No), the CPU 211 goes to B in FIG. 13. The presence of the marker segment APP6 does not ensure the presence of the image processing control information GI. After determination of the presence of the marker segment APP6 in the image file GF, it is thus required to determine whether the image processing control information GI is included in the marker segment APP6.

In the case of successful detection of the identifier ID_GI (step S200: Yes), the CPU 211 determines whether the GI tag 1040 is described (stored) in the 0^{th}_IFD 1022, based on detection or no detection of the GI tag name 1040a (step S210). In the case of failed detection of the GI tag 1040 (step S210: No), the CPU 211 executes standard image quality adjustment without the image processing control information GI (step S280) and exits from this processing routine. Before execution of this decision step, it has been confirmed at least that the marker segment APP6 is the application marker segment APP that is expected to include the image processing control information GI (step S200: Yes). Failed detection of the GI tag 1040 is thus ascribed to some trouble, for example, a retrieval error or a file damage.

In the case of successful detection of the GI tag 1040 (step S210: Yes), the CPU 211 subsequently uses the offset values 1040c to the GI data included in the GI tag 1040 to determine whether the identifier GI_M for identifying the GI data is detected in the 0^{th} data 1023 (step S220). In the case of failed detection of the identifier GI_M (step S220: No), the CPU 211 executes the standard image quality adjustment (step S280) and exits from this processing routine. Before execution of this decision step, it has been confirmed at least that the GI tag 1040 is included in the image file GF (APP6) (step S210: Yes). Failed detection of the identifier GI_M is thus ascribed to some trouble, for example, a retrieval error or a file damage.

In the case of successful detection of the identifier GI_M (step S220: Yes), the CPU 211 acquires the GI data (GIapp) (step S230). The CPU 211 extends the image data GD included in the read-out image file GF and sequentially carries out matrix algebra with a matrix S on the extended image data GD, gamma correction with gamma correction values specified by the acquired GIapp data, and matrix algebra with a matrix N⁻¹M including a matrix M, so as to implement color conversion of YCbCr into wRGB (step S240).

The image file GF processed according to this flowchart stores JPEG image data, which represent YCbCr data in a compressed form. RGB data are generally used for image processing executed by the personal computer PC and the printer. Extension of the JPEG data (decoding) and the color conversion of YCbCr data into RGB data are accordingly required. The matrix S is typically used for conversion of YCbCr data into RGB data in the JFIF format as is known in the art, and is thus not specifically described here. Linearization of the image data GD in the course of color conversion is desired, so that the gamma correction is carried out with the gamma correction values specified by the GI data to attain linearization of the image data GD.

The procedure of this embodiment carries out RGB to wRGB color conversion with the matrix N⁻¹M including the matrix M, which takes into account the color reproduction characteristics of the color printer 20, in addition to the general YCbCr to RGB color conversion with the matrix S. The matrix M has elements specified by the GIapp data, and is used to convert the color space from an RGB color space (target color space) that defines (specifies) RGB data after the matrix algebra with the matrix S into an XYZ color space that is a device-dependent color space. When the RGB data after the matrix algebra with the matrix S have RGB values out of the color range of an sRGB color space, a wRGB color space at least partly having a wider color range than the sRGB color space is specified as the color space defining the RGB data after matrix algebra with the matrix S. This arrangement effectively prevents loss of the RGB values and leads to a subsequent wider wRGB color space (working color space). The matrix N is used to convert the color space from an RGB color space allowed by the color printer 20, for example, a wRGB color space, into an XYZ color space. The matrix N⁻¹M is a composite matrix to attain color conversion from RGB to XYZ to wRGB.

The CPU 211 carries out image quality adjustment of the color-converted RGB data with parameter values specified by the GIapp data (step S250). According to a concrete procedure, the CPU 211 analyzes the image data GD in units of pixel and obtains values of various characteristic parameters representing the characteristics of the image data GD, for example, image statistics like a minimum luminance, a maximum luminance, and a representative lightness. The CPU 211 specifies correction values to cancel or at least reduce differences between reference values preset for the respective characteristic parameters stored in the ROM 212 and the image statistics obtained by the analysis, and corrects the RGB values of the image data GD. The correction of the image data GD, for example, corrects a tone curve, which defines a relation between input and output, with the specified correction values and substitutes the image data GD as an input into the corrected tone curve. The parameter values specified by the GI data are used to change the degree of cancellation or the degree of reduction (the amount of correction) of the difference between the reference value and the image statistic, while being directly reflected on the amount of correction (the correction value). This arrangement ensures execution of the image quality adjustment reflecting the intention of the photographer, when the photographer desires a brighter image and sets a large positive value to an exposure correction value or when a twilight mode is specified as a preset shooting mode.

The CPU 231 then carries out color conversion to convert the resulting image data (RGB image data) after the auto image quality adjustment into CMYK data (step S260). This process converts the color system of the image data to the CMYK color system adopted by the color printer 20 for execution of printing. A concrete procedure refers to a lookup table, which maps the RGB color system to the CMYK color system and is stored in the ROM 212.

On completion of the above series of image processing, the CPU 211 carries out a print output process of the resulting image data (step S270), and exits from this processing routine. In the print output process, the CPU 211 successively executes a halftoning process and a resolution conversion process and transmits the processed data as raster data to the printing unit 21.

A subsequent flow of the processing (after B) in the case of no detection of the marker segment APP6 in the image file GF is discussed below by referring to FIG. 13. The subsequent flow of the processing executes image quality adjustment with the image processing control information GI (GI data) having the offset values specified by the GI tag 2050 of the marker segment APP1 or the Makernote tag 2060c (GI tag 2070) of the Exif tag 2060, in response to no detection of the marker segment APP6. In the case where the image file GF complies with the TIFF file format, on the other hand, the subsequent flow of the processing executes image quality adjustment with the image processing control information GI (GI data 304, 306) having the offset values specified by the GI tag 2050 of the GI_IFD 303 or the Makernote tag 2060c (GI tag 2070) of the Exif_IFD 305 in the TIFF file format.

The CPU 211 determines whether the GI tag 2050 is described (stored) in the IFD, based on detection or no detection of the GI tag name (tag number) 2050a (step S300). In the case of successful detection of the GI tag 2050 (step S300: Yes), the CPU 211 uses the offset values 2050c to the GI data included in the GI tag 2050 to determine whether the identifier GI_M for identifying the GI data is detected in the 0^{th} data 2023 or the GI data 304 (step S310). In the case of successful detection of the identifier GI_M (step S310: Yes), the CPU 211 obtains the GI data (GItiff) (step S320) and goes to step S370.

In the case of failed detection of the GI tag 2050 (step S300: No) or in the case of failed detection of the identifier GI_M (step S310: No), the CPU 211 subsequently determines whether the Exif tag 2060 is described (stored) in the IFD, based on detection or no detection of the Exif tag name (version name) 2060a (step S330). In the case of successful detection of the Exif tag 2060 (step S330: Yes), the CPU 211 then determines whether the GI tag 2070 is included in the Makernote tag 2060c, based on detection or no detection of the GI tag name 2070a (step S340). In the case of successful detection of the GI tag 2060 (step S340: Yes), the CPU 211 uses the offset values 2070c to the GI data included in the GI tag 2070 to determine whether the identifier GI_M for identifying the GI data is detected in the 0^{th} data 2023 or the Exif data 306 (step S350). In the case of successful detection of the identifier GI_M (step S350: Yes), the CPU 211 obtains the GI data (GIExif) (step S360) and goes to step S370.

In the case of failed detection of the Exif tag 2060 (step S330: No), the CPU 211 executes standard image quality adjustment without the image processing control information GI (step S390) and exits from this processing routine. In the case of failed detection of the GI tag 2070 (step S340: No) or in the case of failed detection of the identifier GI_M (step S350: No), the CPU 211 goes to C in FIG. 14.

The CPU 211 executes a series of image quality adjustment with the GI data (GItiff or GIExif) (steps S370, S372, S374, and S380). The processing of these steps corresponds to and is identical with the processing of steps S240, S250, S260, and S270 shown in FIG. 12.

A subsequent flow of the processing (after C) in the case of failed detection of the GI tags 2050 and 2070 or in the case of failed detection of the identifier GI_M is discussed below by referring to FIG. 14. The subsequent flow of the processing converts the shooting information PI included in the shooting information tag 2060b of the Exif tag 2060 into GI-equivalent data GI′ and executes image quality adjustment with the GI-equivalent data GI′, in response to failed detection of the image processing control information GI, specifically GItiff or GIExif.

The CPU 211 obtains the shooting information PI included in the shooting information tag 2060b of the Exif tag 2060 and converts the obtained shooting information PI into GI-equivalent data GI′, for example, based on a mapping shown in FIG. 15 (step S400). The conversion of the shooting information PI into the GI-equivalent data GI′, for example, maps the shooting situation to the mode specified in the GI data, the settings like the setting of contrast for shooting to the parameters of the contrast and the like specified in the GI data, and the information like the gain control to the noise reduction level. As mentioned previously, the shooting information PI simply records the shooting conditions (environment) at the time of photographing and can not compensate for all the image processing control information GI. The shooting conditions, however, naturally include some pieces of information that express the photographer's intention. Such information is converted into the image processing control information GI.

The CPU 211 extends the image data GD and converts the color space of the extended image data GD from the YCbCr color space into the RGB color space (step S410). The procedure carries out the color conversion with the matrix S as discussed above, while not executing the RGB-wRGB color conversion via the target color space, which is available in the presence of the GI data.

The CPU 211 executes image quality adjustment of the resulting RGB data with the parameter values specified by the GI-equivalent data GI′ thus obtained (step S420). According to the concrete procedure, the CPU 211 analyzes the image data GD in units of pixel to obtain values of various characteristic parameters (image statistics) representing the characteristics of the image data GD, and corrects the RGB values of the image data GD with the image statistics, reference values, and the GI-equivalent data GI′ to cancel or at least reduce the differences between the reference values and the image statistics. The correction of the image data GD, for example, corrects a tone curve, which defines a relation between input and output, with the specified correction values and substitutes the image data GD as an input into the corrected tone curve. The parameter values specified by the GI-equivalent data GI′ are used to change the degree of cancellation or the degree of reduction (the amount of correction) of the difference between the reference value and the image statistic, while being directly reflected on the amount of correction (the correction value). This arrangement ensures execution of the image quality adjustment reflecting the shooting conditions set by the photographer.

The CPU 211 then carries out color conversion to convert the resulting image data (RGB image data) after the auto image quality adjustment into CMYK data (step S430). This process converts the color system of the image data to the CMYK color system adopted by the color printer 20 for execution of printing. A concrete procedure refers to the lookup table, which maps the RGB color system to the CMYK color system and is stored in the ROM 212.

On completion of the above series of image processing, the CPU 211 carries out a print output process of the resulting image data (step S4400), and exits from this processing routine. In the print output process, the CPU 211 successively executes a halftoning process and a resolution conversion process and transmits the processed data as raster data to the printing unit 21.

As described above, the color printer 20 (image processing apparatus) of the embodiment preferentially retrieves the image processing control information GI in the image file GF, which may store both the image processing control information GI and the shooting information PI, and executes the image quality adjustment with the GI data (GIapp, GItiff, or GIexif) obtained by the retrieval to output the image reflecting the intention of the photographer.

The image file GF used in this embodiment is designed to have the common file structure after the TIFF header 1021, 2021, or 300. This structure desirably standardizes the procedure of retrieval after the TIFF header executed by the color printer 20.

The image file GF used in this embodiment has identifiers and tag numbers on multiple hierarchical levels, in order to prevent wrong identification of the GI data. The color printer 20 of the embodiment retrieves these identifiers and tag numbers, prior to identification of the GI data. This arrangement effectively prevents wrong identification of the GI data and ensures execution of adequate image quality adjustment.

In the case of failed acquisition (retrieval) of the GI data, the procedure converts the shooting information PI, which is likely to be included in the image file GF, into the GI-equivalent data GI′ and carries out the image quality adjustment, thus ensuring output of the image reflecting the intention of the photographer.

Modifications

The above embodiment describes the auto image quality adjustment process based on fixed reference values. One possible modification provides auto image quality adjustment buttons, for example, to select the direction of correcting the lightness between the brighter and the darker, on an operation panel of the color printer 20. The respective correction values are varied according to the directions of correcting the lightness and other parameters selected through the operations of the auto image quality adjustment buttons.

The above embodiment regards the auto image quality adjustment process. Another possible modification provides auto image quality adjustment buttons on the operation panel of the color printer 20. The auto image quality adjustment process discussed in the above embodiment may be executed only in the case of selection of an auto image quality adjustment mode through the operation of the auto image quality adjustment button.

In the structure of the above embodiment, the color printer 20 executes, without the assistance of the personal computer PC, the whole series of image processing and creates a dot pattern according to the generated image data GD on a printing medium. All or part of the image processing may alternatively be executed by the computer. In the latter case, an image data processing application, such as a retouch application or a printer driver, installed in a hard disk or the like of the computer has the image processing functions described above with reference to FIGS. 11 through 15. The image file GF generated by the digital still camera 12 is transmitted to the computer via a cable or via the memory card MC. For example, the application is activated on the computer through the user's operations to perform input of the image file GF, analysis of the shooting information PI, conversion of the image data GD, and image quality adjustment. In another example, the application is automatically activated in response to detection of insertion of the memory card MC or in response to detection of attachment of the cable to automatically perform input of the image file GF, retrieval of the GI data, conversion of the image data GD, and image quality adjustment.

Another possible modification may allow for selection of the characteristic parameter values for execution of the auto image quality adjustment. One applicable structure provides the color printer 20 with parameter selection buttons or selection buttons of the shooting mode as a combination of preset parameters suitable for the subject, and selects the parameters for execution of the auto image quality adjustment through the operations of these selection buttons. In the case where the auto image quality adjustment is executed on the personal computer, parameters for execution of the auto image quality adjustment may be selected on a user interface of a printer driver or a retouch application.

In the structure of the above embodiment, the color printer 20 is used as the output device. The output device may be a display device, such as a CRT, an LCD, or a projector. In such cases, the display device functioning as the output device executes an image processing program (display driver) to implement the image processing described above with reference to FIGS. 11 through 15. When the CRT or the like functions as a display device of the computer, the computer executes the image processing program. Here the eventually output image data has the RGB color space, instead of the CMYK color space.

The resulting display on the display device, such as the CRT, reflects the image processing control information GI, as the resulting print by the color printer 20 reflects the information obtained at the time of generating the image data. This arrangement ensures accurate display of the image data GD generated by the digital still camera 12.

The embodiment regards the image files GF complying with the JFIF, Exif, and TIFF file formats. The technique of the invention is, however, not restricted to the image files of these formats but is applicable to any image files including the image data GD and the image processing control information GI at least related to the image data GD.

In the embodiment discussed above, the digital still camera 12 and the color printer 20 are only illustrative and are not restricted to the structure discussed above. The digital still camera 12 is required to have at least the function of generating the image file GF discussed in the embodiment. The color printer 20 is required to have at least the functions of retrieving the image processing control information GI in the image file GF, which may store both of the image processing control information GI and the shooting information PI, carrying out auto image quality adjustment with the retrieved GI data or with the GI-equivalent data GI′ obtained by conversion of the shooting information PI, and outputting (printing) the processed image.

In the structure of the above embodiment, the image data GD and the GI data (the image processing control information GI) are included in the identical image file GF. The image data GD and the GI data may not be stored in an identical file. The requirement is that the image data GD is related to the GI data. One possible modification generates mapping data to relate the image data GD to the GI data, stores one or multiple image data GD and the GI data in separate files, and refers to the GI data related to the image data GD at the time of processing the image data GD. In this modified structure, the image data is inseparably integrated with the GI data in the course of image processing with the GI data. This gives the substantially equivalent functions to those attained by storage in the identical file. The technique is also applicable to video files stored in optical disk media, such as CD-ROMs, CD-Rs, DVD-ROMs, and DVD-RAMs.

The image processing apparatus and the image processing method of the invention are described above with reference to the embodiments. The embodiments are to be considered in all aspects as illustrative and not restrictive. There may be many modifications, changes, and alterations without departing from the scope or spirit of the main characteristics of the present invention. All changes within the meaning and range of equivalency of the claims are therefore intended to be embraced therein.

What is claimed is:

1. An image processing method that utilizes either of shooting information representing a shooting condition of image data and image processing control information for specifying an image processing condition of the image data, either of which is related to the image data, and thereby makes the image data subjected to a series of image processing, said image processing method comprising:
acquiring the image data;
retrieving either of the shooting information and the image processing control information, either of which is related to the acquired image data; and
in the case of successful retrieval of the image processing control information, executing the series of image processing of the image data according to the image processing control information.

2. An image processing method in accordance with claim 1, said image processing method further comprising:
in the case of successful retrieval of the image processing information, not executing retrieval of the shooting information.

3. An image processing apparatus that utilizes either of shooting information representing a shooting condition of image data and image processing control information for specifying an image processing condition of the image data, either of which is related to the image data, and thereby makes the image data subjected to a series of image processing, said image processing apparatus comprising:
an image data acquisition unit that acquires the image data;
an image processing information retrieval unit that retrieves either of the shooting information and the image processing control information, either of which is related to the acquired image data; and
an image processing unit that, in the case of successful retrieval of the image processing control information, executes the series of image processing of the image data according to the image processing control information.

4. A recording medium in which an image processing program is recorded, said image processing program causing a computer to utilize either of shooting information representing a shooting condition of image data and image processing control information for specifying an image processing condition of the image data, either of which is related to the image data, and thereby make the image data subjected to a series of image processing, said image processing program comprising:
a program command that acquires the image data;
a program command that retrieves either of the shooting information and the image processing control information, either of which is related to the acquired image data; and
a program command that, in the case of successful retrieval of the image processing control information, executes the series of image processing of the image data according to the image processing control information.

5. An image processing method that utilizes either of shooting information representing a shooting condition of image data and image processing control information for specifying an image processing condition of the image data, either of which is related to the image data, and thereby makes the image data subjected to a series of image processing, said image processing method comprising:
acquiring the image data;
retrieving either of the shooting information and the image processing control information, either of which is related to the acquired image data; and
in the case of failed retrieval of the image processing control information but successful retrieval of the shooting information, executing the series of image processing to the image data, based on the shooting information.

6. An image processing method in accordance with claim 5, said image processing method further comprising:
in the case of failed retrieval of both the image processing control information and the shooting information, executing the series of image processing of the image data according to default image processing control information, which is general-purpose image processing information set for preset image data.

7. An image processing method in accordance with claim 5, wherein the executing the image processing to the image data is carried out by converting at least part of the shooting information into image processing control information and executing the series of image processing of the image data according to the converted image processing control information.

8. An image processing apparatus that utilizes either of shooting information representing a shooting condition of image data and image processing control information for specifying an image processing condition of the image data, either of which is related to the image data, and thereby makes the image data subjected to a series of image processing, said image processing apparatus comprising:
an image data acquisition unit that acquires the image data;
an image processing information retrieval unit that retrieves either of the shooting information and the image processing control information, either of which is related to the acquired image data; and
an image processing unit that, in the case of failed retrieval of the image processing control information but successful retrieval of the shooting information, executes the series of image processing of the image data, based on the shooting information.

9. A recording medium in which an image processing program is recorded, said image processing program causing a computer to utilize either of shooting information representing a shooting condition of image data and image processing control information for specifying an image processing condition of the image data, either of which is related to the image data, and thereby make the image data subjected to a series of image processing, said image processing program comprising:
a computer command that acquires the image data;
a computer command that retrieves either of the shooting information and the image processing control information, either of which is related to the acquired image data; and
a computer command that, in the case of failed retrieval of the image processing control information but successful retrieval of the shooting information, executes the series of image processing of the image data, based on the shooting information.

10. An image processing method that utilizes either of shooting information representing a shooting condition of image data and image processing control information for specifying an image processing condition of the image data, either of which is related to the image data, as image processing information and thereby makes the image data subjected to a series of image processing, said image processing method comprising:
acquiring the image data;
retrieving either of the shooting information and the image processing control information, either of which is related to the acquired image data; and
in the case of successful retrieval of the image processing control information, executing the series of image processing of the image data according to the image processing control information, while in the case of failed retrieval of the image processing control information, executing the series of image processing of the image data, based on the shooting information.

11. An image processing method in accordance with claim 10, said image processing method further comprising:
in the case of successful retrieval of the image processing information, not executing retrieval of the shooting information.

12. An image processing method in accordance with claim 10, said image processing method further comprising:
in the case of failed retrieval of both the image processing control information and the shooting information, executing the series of image processing of the image data according to default image processing control information, which is general-purpose image processing information set for preset image data.

13. An image processing method in accordance with claim 10, wherein the executing the image processing to the image data is carried out by converting at least part of the shooting information into image processing control information and executing the series of image processing of the image data according to the converted image processing control information.

14. An image processing apparatus that utilizes either of shooting information representing a shooting condition of image data and image processing control information for specifying an image processing condition of the image data, either of which is related to the image data, as image processing information and thereby makes the image data subjected to a series of image processing, said image processing apparatus comprising:
an image data acquisition unit that acquires the image data;
an image processing information retrieval unit that retrieves either of the shooting information and the image processing control information, either of which is related to the acquired image data; and
an image processing unit that, in the case of successful retrieval of the image processing control information, executes the series of image processing of the image data according to the image processing control information, while in the case of failed retrieval of the image processing control information, executing the series of image processing of the image data, based on the shooting information.

15. A recording medium in which an image processing program is recorded, said image processing program causing a computer to utilize either of shooting information representing a shooting condition of image data and image processing control information for specifying an image processing condition of the image data, either of which is related to the image data, as image processing information and thereby make the image data subjected to a series of image processing, said image processing program comprising:
a program command that acquires the image data;
a program command that retrieves either of the shooting information and the image processing control information, either of which is related to the acquired image data; and
a program command that, in the case of successful retrieval of the image processing control information, executes the series of image processing of the image data according to the image processing control information, while in the case of failed retrieval of the image processing control information, executing the series of image processing of the image data, based on the shooting information.

16. An image processing method that carries out a series of image processing with an image file that stores image data and at least either of shooting condition, which represents a condition of generating the image data, and image processing control information, which specifies an image processing condition applied for processing of the image data and has a preset storage position according to a record format, said image processing method comprising:
acquiring the image file;
specifying the record format included in the acquired image file;
retrieving the image processing control information at the preset storage position according to the specified record format; and
in the case of successful retrieval of the image processing control information, executing the series of image processing of the image data according to the retrieved image processing control information.

17. An image processing method in accordance with claim 16, said image processing method further comprising:
in the case of failed retrieval of the image processing control information at the preset storage position, retrieving the shooting information; and
in the case of successful retrieval of the shooting information, converting at least part of the retrieved shooting information into image processing control information and executing the series of image processing of the image data according to the converted image processing control information.

18. An image processing method in accordance with claim 16, wherein the image file is a JPEG data storage file having at least either of a first application marker segment, which is capable of storing the image processing control information, and a second application marker segment, which is capable of storing at least either of the image processing control information and the shooting information on an identical hierarchy, and
the retrieving the image processing control information is sequentially carried out firstly at the preset storage position in the first application marker segment, and then at the preset storage position in the second application marker segment.

19. An image processing method in accordance with claim 16, wherein the image file is a JPEG data storage file having at least either of a first application marker segment, which is capable of storing the image processing control information, and a second application marker segment, which is capable of storing at least either of the image processing control information and the shooting information on an identical hierarchy, and
the retrieving the image processing control information is sequentially carried out firstly at the preset storage position in the first application marker segment, and then at the preset storage position in the second application marker segment.

20. An image processing method in accordance with either one of claims 18 and 19, said image processing method further comprising:
retrieving the shooting information in the second application marker segment, wherein the second application marker segment is capable of storing the image processing control information on a lower hierarchy than the shooting information; and
in the case of failed retrieval of the image processing control information at the preset storage positions in the first application marker segment and in the second application marker segment and successful retrieval of the shooting information by said shooting information retrieval means, carrying out retrieval of the image processing control information on the lower hierarchy than the shooting information in the second application marker segment.

21. An image processing method in accordance with claim 20, said image processing method further comprising:
in the case of failed retrieval of the image processing control information on the lower hierarchy than the shooting information in the second application marker segment, converting at least part of the shooting information into image processing control information and executing the series of image processing of the image data according to the converted image processing control information.

22. An image processing method in accordance with claim 16, wherein the image file is a TIFF file having at least either of a first image file directory, which is capable of storing the image processing control information, and a second image file directory, which is capable of storing the shooting information, and
the retrieving the image processing control information is sequentially carried out firstly in the first image file directory, and then in the second image file directory.

23. An image processing method in accordance with claim 22, said image processing method further comprising:
retrieving the shooting information in the second image file directory, wherein the second image file directory is capable of storing the image processing control information on a lower hierarchy than the shooting information; and
in the case of failed retrieval of the image processing control information in the first image file directory and successful retrieval of the shooting information by said shooting information retrieval means, retrieving the image processing control information on the lower hierarchy than the shooting information in the second image file directory.

24. An image processing method in accordance with claim 23, said image processing method further comprising:
in the case of failed retrieval of the image processing control information on the lower hierarchy than the shooting information in the second image file directory, converting at least part of the shooting information into image processing control information and executing the series of image processing of the image data according to the converted image processing control information.

25. An image processing apparatus that carries out a series of image processing with an image file that stores image data and at least either of shooting condition, which represents a condition of generating the image data, and image processing control information, which specifies an image processing condition applied for processing of the image data and has a preset storage position according to a record format, said image processing apparatus comprising:
an image file acquisition unit that acquires the image file;
a format specification unit that specifies the record format included in the acquired image file;
an image processing control information retrieval unit that retrieves the image processing control information at the preset storage position according to the specified record format; and
an image processing unit that, in the case of successful retrieval of the image processing control information, executes the series of image processing of the image data according to the retrieved image processing control information.

26. A recording medium in which an image processing program is stored, said image processing program causing a computer to carry out a series of image processing with an image file that stores image data and at least either of shooting condition, which represents a condition of generating the image data, and image processing control information, which specifies an image processing condition applied for processing of the image data and has a preset storage position according to a record format, said image processing program comprising:
a program command that acquires the image file;
a program command that specifies the record format included in the acquired image file;
a program command that retrieves the image processing control information at the preset storage position according to the specified record format; and
a program command that, in the case of successful retrieval of the image processing control information, executes the series of image processing of the image data according to the retrieved image processing control information.

27. An image processing method that carries out a series of image processing with an image file that stores JPEG data and at least one of an application marker segment APP0, which represents a JFIF file, an application marker segment APP1, which is capable of storing shooting information representing a condition of generating image data, as well as image processing control information for specifying an image processing condition applied for the processing of the image data on an identical hierarchy and represents an Exif file, and an application marker segment APP6, which is capable of storing the image processing control information, said image processing method comprising:
acquiring the image file;
detecting one or multiple application marker segments; and
in the case of simultaneous detection of the application marker segment APP0 and the application marker segment APP1 by said detection means, not executing the series of image processing of the image data according to the image processing control information.

28. An image processing method in accordance with claim 27, said image processing method further comprising:
in the case of detection of any of the application marker segment APP1, a combination of the application marker segment APP1 and the application marker segment APP6, and a combination of the application marker segment APP0 and the application marker segment APP6, executing the series of image processing of the image data according to the image processing control information.

29. An image processing apparatus that carries out a series of image processing with an image file that stores JPEG data and at least one of an application marker segment APP0, which represents a JFIF file, an application marker segment APP1, which is capable of storing shooting information representing a condition of generating image data, as well as image processing control information for specifying an image processing condition applied for the processing of the image data on an identical hierarchy and represents an Exif file, and an application marker segment APP6, which is capable of storing the image processing control information, said image processing apparatus comprising:
an image file acquisition unit that acquires the image file;
a detection unit that detects one or multiple application marker segments; and
an image processing unit that, in the case of simultaneous detection of the application marker segment APP0 and the application marker segment APP1 by said detection means, does not execute the series of image processing of the image data according to the image processing control information.

30. A recording medium in which an image processing program is stored, said image processing program causing a computer to carry out a series of image processing with an image file that stores JPEG data and at least one of an application marker segment APP0, which represents a JFIF file, an application marker segment APP1, which is capable of storing shooting information representing a condition of generating image data, as well as image processing control information for specifying an image processing condition applied for the processing of the image data on an identical hierarchy and represents an Exif file, and an application marker segment APP6, which is capable of storing the image processing control information, said image processing program comprising:
a program command that acquires the image file;
a program command that detects one or multiple application marker segments; and
a program command that, in the case of simultaneous detection of the application marker segment APP0 and the application marker segment APP1 by said detection means, does not execute the series of image processing of the image data according to the image processing control information.
